(19) United States
(12) Patent Application Publication
(10) Pub. No.: US 2007/0107427 A1
(43) Pub. Date: May 17, 2007

(54) Method and control device for controlling a turbocharger having a controllable turbine flow cross-section

(75) Inventor: Matthias Hofstetter, Ringsheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c. F. Porsche Aktiengesellschaft, Stuttgart (DE)

(21) Appl. No.: 11/595,992

(22) Filed: Nov. 13, 2006

(30) Foreign Application Priority Data
Nov. 14, 2005 (DE) 10 2005 054 524.6

(51) Int. Cl. F02D 23/00; F02B 33/44

(52) U.S. Cl. 60/602; 60/605.1

(57) ABSTRACT

A method is introduced for controlling a turbocharger that generates a variable charging pressure for an internal-combustion engine by using a controllable turbine flow cross-section and whose turbine flow cross-section, when an increased charging pressure is demanded, is temporarily reduced and increased again. A measure for an exhaust gas mass flow through the turbine flow cross section is formed and the enlargement of the turbine cross-section takes place as a function of that measure. In addition, a control device is introduced that implements the method.

### RELATED APPLICATIONS

This application claims priority to German Patent Application No. 102005054524.6-13, the disclosure of which is incorporated herein in its entirety.

### BACKGROUND AND SUMMARY OF THE INVENTION

The present invention relates to a method of controlling a turbocharger that generates a variable charging pressure for an internal-combustion engine by using a controllable turbine flow cross-section and whose turbine flow cross-section, when an increased charging pressure is demanded, is temporarily reduced and increased again. The present invention also relates to a control device that controls the process.

A method of the foregoing type is generally known from the series “Dictionary of Technical Science”, Volume 103, “Exhaust Gas Turbocharger”, Moderne Industrie Publishers, D-86896 Landsberg/Lech, ISBN 3-478-93263-7, Page 40. This reference relates to a turbocharger with an adjustable turbine geometry (VTG) in which the turbine flow cross-section is reduced by the closing of guide blades, in order to generate a higher pressure gradient between the turbine inlet and the turbine outlet. The desired increased charging pressure will then occur as a result of the higher pressure gradient. At the start of the vehicle acceleration from low rotational speeds, the flow cross-section should be minimal and should then be enlarged again with increasing rotational speed and be adapted to the respective operating point.

In the case of internal-combustion engines with turbochargers without a controllable turbine flow cross-section, a certain delay occurs between a demand for a high charging pressure and its implementation. Thus, Otto engines, for example, are operated in a throttled manner outside the full load. Their turbine-driving exhaust gas mass flow therefore varies with the torque demand by a driver. If a higher torque and therefore a higher charging pressure is desired, the exhaust gas mass flow produced by the internal-combustion engine first has to rise in order to increase the rotational speed of the turbine and thus increase the charging pressure.

This delay is undesirable and can be reduced by the known controlling of the turbine flow cross-section. However, the above-mentioned delay is not completely eliminated by the known control.

In view of this background, an object of the invention is to achieve a further reduction of the above-mentioned delay.

In the case of a method of the initially mentioned type, this object is achieved in that a quantity for an exhaust gas mass flow through the turbine flow cross-section is formed and the enlargement of the turbine flow cross-section takes place as a function of that measure. Furthermore, this object is achieved by a control device that controls the implementation of this process.

A turbine can basically be operated with a subcritical or supercritical flow. In each case, a pressure gradient occurs over the turbine. While the exhaust gas mass flow through the turbine also increases in the case of a subcritical flow with an increasing value of the pressure gradient, when the flow is supercritical, an exhaust gas mass flow occurs that is almost constant and will no longer significantly increase with a further rise of the pressure gradient. As a result, the exhaust back pressure that builds up as ram pressure in front of the turbine may undesirably rise. An excessively high exhaust back pressure has a reducing tendency with respect to charges of combustion chambers of the internal-combustion engine with air (in the case of diesel engines or Otto engines with direct injection) or fuel-air mixture (in the case of engines with intake pipe injection or carburetors). Both are counterproductive with a view to a rapid torque buildup.

If, in contrast, a high braking effect of the internal-combustion engine is desired, a high exhaust back pressure may be helpful in order to increase the charge cycle work of the internal-combustion engine.

In each case, the present invention permits a controlling of the turbine flow cross-section that meets the demand, achieves the above-mentioned advantages and avoids the disadvantages.

Here, it is currently preferred that the enlargement of the turbine flow cross-section as a function of the quantity takes place such that a subcritical flow exists in the flow cross-section. When a fast torque increase is desired, this characteristic effectively limits a counterproductive rise of the exhaust back pressure.

It is also preferable for the enlargement of the turbine cross-section to take place as a function of the quantity such that a subcritical flow just barely still exists in the flow cross-section. This characteristic permits an adjustment of values of the transfer of kinetic energy from the exhaust gas to the turbine wheel that is optimal for the torque buildup while the exhaust back pressure is simultaneously low. The present invention has advantages particularly in Otto engines when torque is to be increased from an operating condition with a low exhaust gas mass flow. In contrast, in the case of diesel engines, the exhaust gas mass flow is comparatively high also at a low load.

### BRIEF DESCRIPTION OF THE DRAWINGS

Other objects, advantages and novel features of the present invention will become apparent from the following detailed description of the invention when considered in conjunction with the accompanying drawings, in which:

FIG. 1 is a schematic view of an internal-combustion engine having a turbocharger;

FIG. 2 is a first schematic sectional view of the turbocharger;

FIG. 3 is a second schematic sectional view of the turbocharger along line III-III of FIG. 2;

FIG. 4 is a characteristic flow curve for a throttle cross-section;

FIG. 5 shows time slopes of torque rises as achieved with the invention and the prior art;

FIG. 6 is a flow chart of an embodiment of a method according to the present invention; and

FIG. 7 are diagrams for forming control variables for the flow cross-section as a function of a quantity for the exhaust gas mass flow.

### DETAILED DESCRIPTION OF THE DRAWINGS

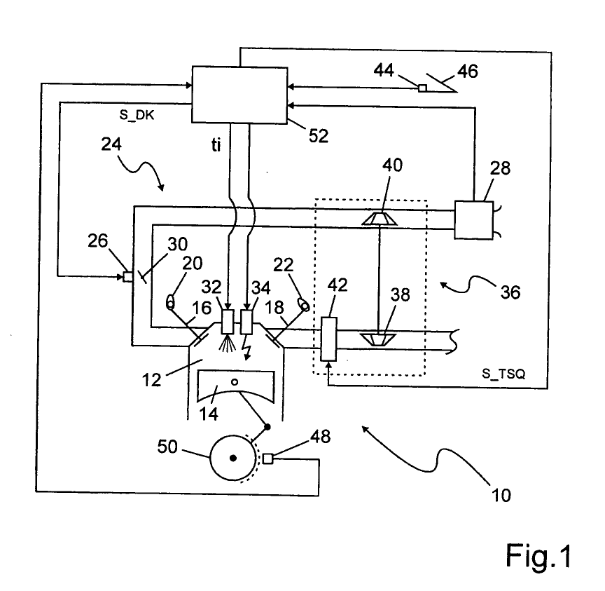

Specifically, FIG. 1 illustrates an internal-combustion engine 10 having at least one combustion chamber 12 that is movably sealed off by a piston 14. A change of charges of the combustion chamber 12 is controlled by an intake valve 16 and an exhaust valve 18. The intake valve 16 is actuated by an intake valve actuator 20 and the exhaust valve 18 is actuated by an exhaust valve actuator 22. The actuators 20, 22 can be implemented as camshafts running with a fixed phase relation, camshafts with a variable phase relation, or as mechanical, hydraulic or electromagnetic adjusting members that permit a variable lift of the intake valve 16 and of the exhaust valve 18.

When the intake valve 16 is open, air or a mixture of air and fuel flows from the intake system 24 into the combustion chamber 12. The quantity of the inflowing air or of the inflowing mixture is adjusted by a throttle valve actuator 26 and/or, when the intake valve actuator 20 has a corresponding further development, by way of a variable lift of the intake valve 16 and is preferably measured by a charge sensor 28 that may be implemented as an air mass flow meter or as an intake pipe pressure sensor.

In the case of one engine type (such as diesel) with a quality control, the throttle valve 30 is not absolutely necessary. The fuel apportioning takes place either in the intake system 24 (intake pipe injection) or by the direct injection of fuel into the combustion chamber 12 (direct injection) by way of an injector 32.

In any case, a combustible fuel-air mixture is generated in the combustion chamber 12, which, in an Otto engine, is ignited by a spark plug 34 or, in a diesel engine, by an injection of fuel into compressed air. Residual gases of the burnt charge of the combustion chamber 12 are expelled by the opened exhaust valve 18.

The internal-combustion engine 10 illustrated in FIG. 1 has an exhaust gas turbocharger 38 whose turbine wheel 38 is driven by the expelled exhaust gases and which itself drives a compressor impeller 40 in the intake system 24. The exhaust gas turbocharger 36 also has a controllable turbine opening cross-section 42.

A driver's torque demands are detected by a driver's intention generator 44 detecting the position of an accelerator pedal 46 of the motor vehicle. An angle-of-rotation sensor 48 traces angle datum marks of a generator wheel 50 non-rotatably connected with a crankshaft of the internal-combustion engine 10 and thereby supplies information concerning the angular position and angular velocity of the crankshaft.

It is understood that a large number of additional sensors may be present for controlling and/or regulating the internal-combustion engine 10 in the case of modern motor vehicle. These sensors detect pressures, temperatures, angular positions of camshafts and/or additional operating parameters of the internal-combustion engine 10. The present invention is therefore not limited to a use on an internal-combustion engine 10 that has only the above-mentioned sensors 28, 44, 48.

For controlling the internal-combustion engine 10, the signals of the charge sensor 28 of the driver's intention generator 44, of the angle-of-rotation sensor 48 and, as required, of the signals of alternative or additional sensors are processed by an engine control device 52 that forms control signals therefrom for controlling functions of the internal-combustion engine 10.

Control signals that influence the exhaust gas mass flow generated by the internal-combustion engine 10 are significant in this context. These are essentially the throttle valve control signals S_DK and the injection pulse widths ti which influence an air mass flow or a fuel mass flow into the combustion chamber 12. Furthermore, the control device 52 controls a turbine opening cross-section TSQ by a control signal S_TSQ.

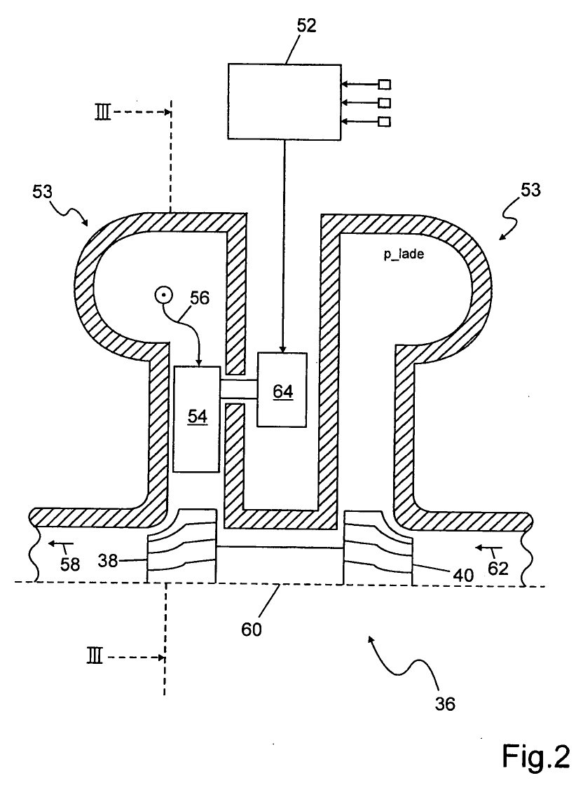

FIG. 2 shows the turbocharger 36 from FIG. 1 in a first cross-sectional representation. The exhaust gas from the turbine housing 53 flows against the turbine wheel 38 from a direction and with a velocity that is defined by the position of the adjustable guide blades 54. The exhaust gas 56 entering into the turbine wheel 38 first has a centripetal component of its flow direction and leaves the turbine wheel 38 in the axial direction 58. The kinetic exhaust gas energy thereby transmitted to the turbine wheel 38 drives the compressor impeller 40 by way of the shaft 60. The compressor impeller 40 takes in air in the axial direction 62, delivers it into the pipe coil and generates the charging pressure p_charge there. The adjustable guide blade 54 is actuated by a drive 64 that is controlled by the control device 52. The drive 64 is implemented in an embodiment as an electric stepping motor.

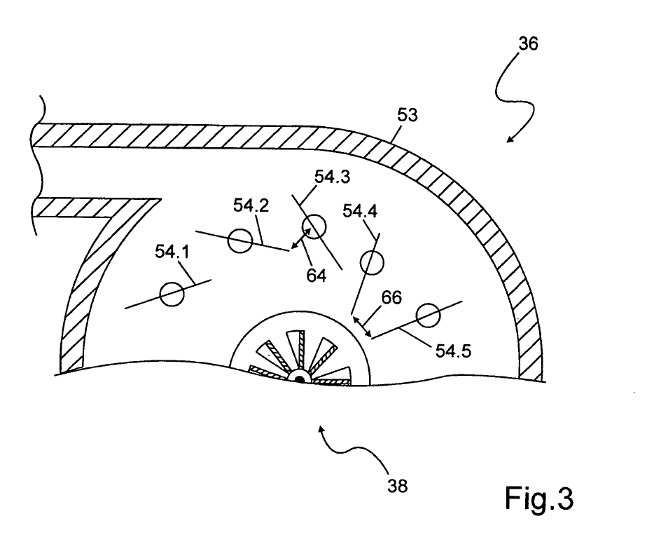

FIG. 3 is another cross-sectional view of the turbine housing 53 along line III-III in FIG. 2 with five guide blades 54.1, 54.2, 54.3, 54.4 and 54.5. Deviating from actuality, in which all guide blades 54.1, 54.2, 54.3, 54.4 and 54.5 are adjusted in the same manner, the guide blades 54.1, 54.2 and 54.3 are illustrated in a closed position and guide blades 54.4. and 54.5 are illustrated in a more open position for purposes of understanding how the present invention operates. The parameter with the number 64 for the flow cross-section TSQ that occurs in the closed position is less than the corresponding parameter 66 which occurs in the more open position. The flow cross-section TSQ(66) is therefore also larger than TSQ(64). The kinetic energy transmitted to the turbine wheel 38 is adjusted with the aid of the guide blades 54.1, 54.2, 54.3, 54.4 and 54.5 by changing the approach flow angle and velocity with respect to the turbine wheel 38. In the closed guide blade position, large tangential components of the flow velocity and a high enthalpy gradient over the turbine wheel 38 lead to a high turbine power and thus to a high charging pressure p_charge. In a fully open position of the guide blades, the maximal exhaust gas mass flow through the turbine occurs at a high centripetal fraction of the velocity vector of the flow while the enthalpy gradient is smaller.

In this context, an essential element of the present invention is the fact that, when a transition is demanded from a low charging pressure to a high charging pressure, the guide blades 54.1, 54.2, 54.3, 54.4 and 54.5 are first adjusted to a comparatively small flow cross-section TSQ(64) and subsequently, as a function of the exhaust gas mass flow through the turbine, to a larger flow cross-section TSQ(66). In this case, the reduction and/or the enlargement of the flow cross-section TSQ takes place such that a subcritical flow occurs and/or is maintained in the flow cross-section TSQ and thus in the entire turbine.

As used herein, a subcritical flow is a flow of subsonic velocity. It is known that, during a flow through a local minimum of a flow cross section, a maximal flow velocity will occur. As the differential pressure over the flow cross-section increases, the mass flow through the flow cross-section grows until the sonic velocity is reached. A further increase of the pressure difference will then result in no further increase of the mass flow.

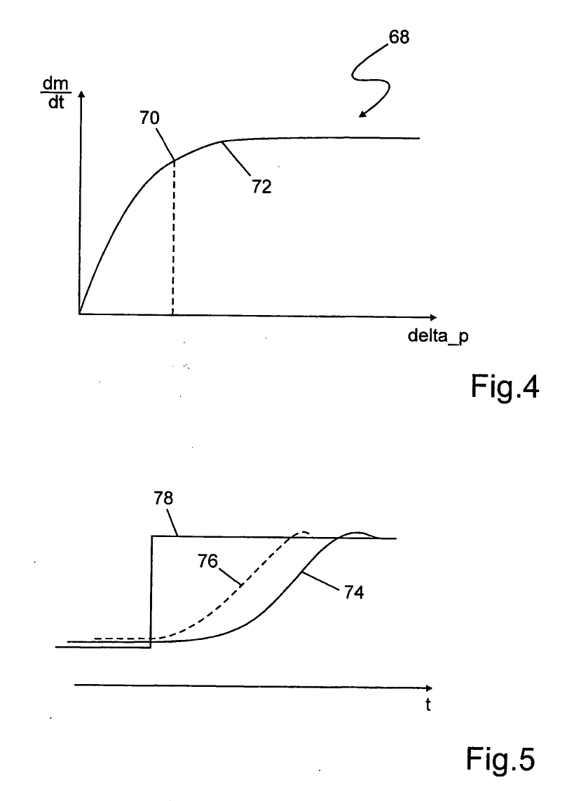

These relationships are qualitatively illustrated in FIG. 4 which shows a characteristic flow curve 68 through a throttle cross-section which can be applied to the flow cross-section TSQ. In this case, the mass flow dm/dt through the throttle cross-section over the pressure difference delta_p is entered over the throttle cross-section. The boundary between the subcritical and supercritical flows is situated at the bend 70 in the characteristic curve 68. After a transition into the supercritical region 72, the pressure difference rises superproportionally, while the mass flow rate dm/dt changes only little.

In the case of the flow cross-section TSQ of the turbine, the pressure difference can rise only as a result of an increase of the pressure on the input side of the turbine, because the output side is coupled by way of the additional exhaust system with the ambient pressure. The exhaust back pressure therefore rises when the flow through the turbine is supercritical. By way of the internal exhaust gas recirculation while, during the so-called valve overlap when the intake valve 16 and the exhaust valve 18 are simultaneously open, a reduced combustion chamber charge with combustible mixture results and an undesirable slowing-down of the torque rise occurs.

This disadvantageous effect is avoided by the adjusting a subcritical flow in the flow cross-section. By adjusting the subcritical flow, a ratio can be achieved between the exhaust gas back pressure, the flow and the gap and the pressure behind the turbine, that is optimal with respect to a desired rapidity of a rise of the torque.

FIG. 5 illustrates this effect by a comparison between a torque rise 74 with a conventional adjustment of the guide blades and a torque rise 76 with the adjustment of the guide blades according to the invention as a function of the exhaust gas flow by way of the turbine in the case of a step-by-step rise of the desired torque 78 in arbitrary units over the time t.

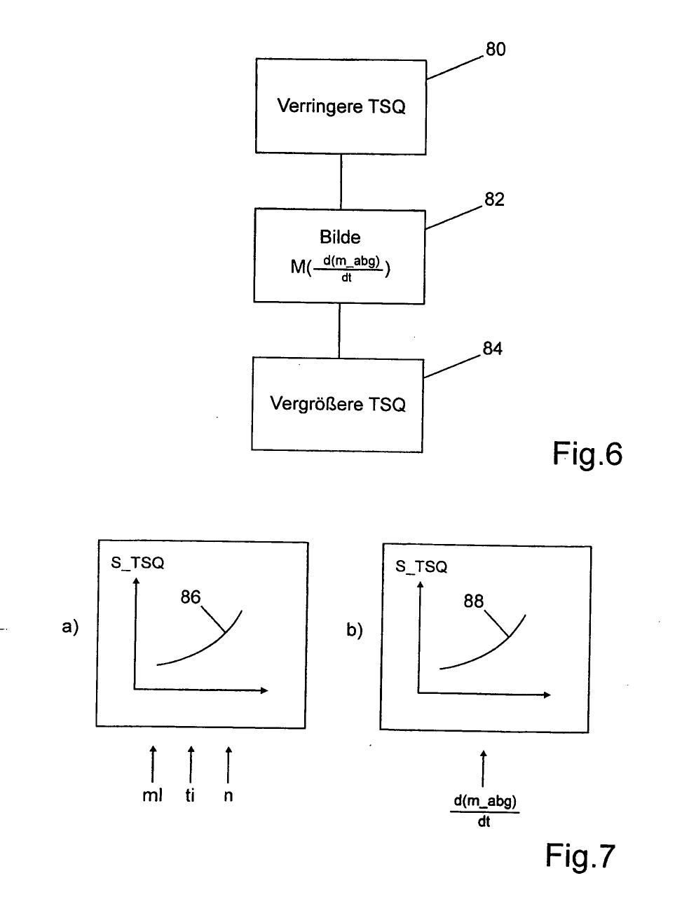

FIG. 6 is a flow chart of an embodiment of a method according to the present invention, as the method is executed by the control device 52 for controlling the turbocharger 36.

In Step 80, the turbine flow cross-section TSQ is reduced when an increased charging pressure p_charge is demanded. Subsequently, in Step 82, a quantity M(d(m_abg)/dt) is formed for the exhaust gas mass flow d(m_abg) through the turbine flow cross-section TSQ. In one embodiment, the reduction of the flow cross-section TSQ is already controlled such that in Step 80 a subcritical flow exists in the flow cross-section TSQ.

In Step 84, the turbine flow cross-section is enlarged as a function of the quantity such that a subcritical flow, particularly just barely still a subcritical flow is present in the flow cross-section. The quantity for the exhaust gas mass flow is preferably generated as a function of an intake air mass flow and/or as a function of a fuel mass flow into combustion chambers of the internal-combustion engine.

The intake air mass flow also significantly determines the exhaust gas mass flow. The fuel mass flow is coupled with the intake air mass flow by way of the fuel/air ratio in combustion chambers and can therefore approximately be used as a proportional substitute value for the intake air mass flow. At lambda=1, the fuel mass amounts to 1/14.7 times the air mass, so that it can be taken into account in a supplementary manner depending on the desired or required precision.

Instead of the intake air mass flow ml, the signal of the driver's intention generator 44 and/or of a product of the combustion chamber charge, the rotational speed and a proportionality factor characterizing the cylinder number and the operating method can also be used, because the exhaust gas mass flow increases with an increasing combustion chamber charge, rotational speed and cylinder number. The values for the combustion chamber charge and the rotational speed are formed in modern control devices 52 anyhow and are therefore known without additional expenditures.

It is also preferable for the quantity for the exhaust gas mass flow to be generated as a function of an ignition point in time and/or of an injection point in time. Both parameters influence the exhaust gas temperature. Late ignitions delay the start of the combustion and thereby increase the exhaust gas temperature. In diesel engines, this applies to injections that trigger a combustion start there.

Finally, both parameters are control variables for the main combustion and, by way of the thermodynamic efficiency, influence the exhaust gas temperature which rises with a combustion start displaced toward late. The exhaust gas temperature influences the kinetic energy of the exhaust gases and the exhaust gas volume flow which, in turn, influences the flow conditions in the turbine flow cross-section. Taking into account the exhaust gas temperature therefore increases the precision with which a transition from subcritical flow to supercritical flow can be approximated in the turbine cross-section.

Further, it is preferable for a control variable S_TSQ for the turbine cross-section to be determined by access to a characteristic curve 86 or a characteristic diagram. The access takes place by way of at least one of the above-mentioned quantities ml, ti, rotational speed n, from which the exhaust gas mass flow is generated, as the characteristic diagram input value. This embodiment can be implemented in a particularly simple manner and is illustrated in FIG. 7a.

An alternative embodiment shown in FIG. 7b provides that a control variable S_TSQ for the turbine flow cross-section is determined by access to a characteristic curve 88 that is addressed by values of an exhaust gas mass flow d(m_abg)/dt. The exhaust gas mass flow can be determined by executing a selection of the above-mentioned quantities with a computer model that permits a precise control of the turbine opening cross-section TSQ in the vicinity of the transition to the supercritical flow.

In the case of internal-combustion engines having several turbochargers with an adjustable turbine geometry, the method and/or one or more of its embodiments is/are correspondingly used for all turbochargers.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method for controlling a turbocharger that generates a variable charging pressure for an internal-combustion engine comprising using a controllable turbine flow cross-section, temporarily reducing and increasing again turbine flow cross-section when an increased charging pressure is demanded, is temporarily reduced and increased again, forming a quantity for an exhaust gas mass flow through the turbine flow cross section, and enlarging the turbine cross-section as a function of the quantity.

2. Method according to claim 1, wherein the reduction and enlargement of the turbine flow cross-section takes place as a function of the quantity such that a subcritical flow is present in the flow cross-section.

3. Method according to claim 2, wherein the enlargement of the turbine flow cross-section takes place as a function of the quantity such that a subcritical flow is still but just barely present in the flow cross-section.

4. Method according to claim 1, wherein the quantity for the exhaust gas mass flow is generated as a function of an intake air mass flow.

5. Method according to claim 1, wherein the quantity for the exhaust gas mass flow as an alternative or in addition is generated as a function of a fuel mass flow in combustion chambers of the internal-combustion engine.

6. Method according to claim 1, wherein the quantity for the exhaust mass flow is additionally generated as a function of an ignition point in time.

7. Method according to claim 1, wherein the quantity for the exhaust mass flow is additionally generated as a function of an injection point in time.

8. Method according to claim 1, wherein a control variable for the turbine flow cross-section is determined by access to a characteristic curve or a characteristic diagram, the access taking place by at least one quantity from which the exhaust gas mass flow is generated as the characteristic diagram input value.

9. Method according to claim 1, wherein a control variable for the turbine flow cross-section is determined by access to a characteristic curve that is addressed by values of an exhaust gas mass flow.

10. Control device for controlling flow cross-section of a turbocharger that generates a variable charging pressure for an internal-combustion engine comprising a system for temporarily reducing and again increasing the flow cross-section and for forming, when an increased charging pressure is demanded, a quantity for an exhaust gas mass flow through the turbine flow cross-section to control the enlargement of the turbine flow cross-section as a function of the quantity.

11. Control device according to claim 10, wherein the system controls implementation of a method that comprises forming a quantity for an exhaust gas mass flow through the turbine cross-section, and enlarging the turbine cross-section as a function of the quantity.

12. Control device according to claim 11, wherein the system controls implementation of a method so that the reduction and enlargement of the turbine flow-cross section takes place as a function of the quantity such that a subcritical flow is present in the flow cross-section.

13. Control device according to claim 12, wherein the system controls implementation of a method so that the enlargement of the turbine flow-cross section takes place as a function of the quantity such that a subcritical flow is still but just barely present in the flow cross-section.

14. Control device according to claim 11, wherein the system controls implementation of a method so that the quantity for the exhaust gas mass flow is generated as function of an intake air mass flow.
